(19) United States
(12) Patent Application Publication
(10) Pub. No.: US 2014/0144824 A1
(43) Pub. Date: May 29, 2014

(54) SEALING APPARATUS FOR A WATER FILTER CANISTER

(71) Applicant: GENERAL ELECTRIC COMPANY, Schenectady, NY (US)

(72) Inventor: Timothy Scott SHAFFER, La Grange, KY (US)

(73) Assignee: GENERAL ELECTRIC COMPANY, Schenectady, NY (US)

(21) Appl. No.: 13/687,195

(22) Filed: Nov. 28, 2012

(51) Int. Cl. B01D 35/30

(52) U.S. Cl. CPC B01D 35/306
USPC 210/136; 210/232; 210/234

(57) ABSTRACT

An apparatus includes a fluid filter canister that includes an internal seal disposed within an inlet recess to provide a seal between a flow of unfiltered fluid into the filter canister and the ambient environment.

### BACKGROUND

The subject matter disclosed herein relates generally to water filtration, and more particularly to filter canisters and the like.

Water filters are used to extract contaminants such as chlorine, chloramine, volatile organic compounds (VOCs), lead, microbes and other undesirable substances. The presence of some such contaminants is a direct result of agricultural chemicals, industrial and municipal wastewater facility processes, water treatment and disinfection byproducts, urban runoff and/or naturally occurring sources in ground water supplies. Others contaminants are introduced after treatment processes within the home and/or municipal sources, for example, from piping and contact with contaminant items.

Household filters can generally be broken into two classes: Point of Entry (POE) filters and Point of Use (POU) filters. POE filters are placed at the entry point of water into the home and continuously filter all water that enters the home. POU filters are installed in areas such as kitchen sinks and refrigerators where water may be used for direct consumption.

A water filter system includes inlet/outlet tubing, a manifold and a filter component. The manifold receives untreated water, directs the water into a filter media, which subsequently directs the treated/filtered water back out for use. The filter media can vary depending on the contaminants targeted for removal. Sediment filters will take out fairly coarse particulate matter greater than 10 microns. Carbon filters, which generally include 60-70% carbon, 2-5% scavenger additives such as titanium dioxide, and 25-40% polyethylene binder dust, will extract contaminants such as chlorine, lead, VOCs, pharmaceuticals, particulates larger than 0.5 microns, and some large microbes such as cysts. The scavenger additives are included to shore-up the block's ability to remove those contaminants that carbon does not have an affinity to adsorb such as heavy metals like lead. Hollow fiber technology, ozone, ultraviolet (UV) lamps and quaternary technologies are also used to extract or destroy microbes, which can be as small as 0.015 microns. In virtually all cases, the filter media will be exhausted over time and use and need to be replaced in order to restore the system's ability to remove contaminants.

It is common practice to have a filter container that can be disassembled from the filter system to permit access to the filter media or to be replaced with a pristine assembly that includes a new filter media. As such, water filters include seals to preclude leaks at the interfaces where the system components are removed from each other. Internally, additional seals are used to partition untreated and treated fluid streams. In many residential applications, replaceable filter canisters are fully encapsulated and designed in a manner that flow is interrupted when the canister is removed. A challenge with these types of residential filters is incorporating a means of sealing the inlet and outlet connection points from each other as well as from the external ambient environment surrounding the filtration system.

Existing approaches for establishing a reliable seal between the stationary filter manifold and the removable components generally include the following: 1) the manifold having a bayonet interface including an outer boss, a seal along the periphery of the outer boss, an inner boss located concentrically below the outer boss, and a seal along the periphery of the inner boss, and the replaceable filter canister including a cap that includes an outer annular wall with no seal that directs water to the filter media and a concentrically lower inner annular wall with no seal to direct treated water back to the outlet of the filter manifold; 2) the replaceable filter having a bayonet interface including an outer boss that directs water to the filter media, a seal along the periphery of the outer boss, an inner boss located concentrically above the outer boss to direct treated water back to the outlet of the filter manifold, and a seal along the periphery of the inner boss, and the filter manifold including a receiving zone that includes an outer annular wall with no seal and a concentrically lower inner annular wall with no seal to direct treated water back to the outlet of the filter manifold; and 3) a separate set of bosses at the same horizontal plane protruding upward from the cylinder and fitting into reciprocal slots within the manifold. The filter canister is mechanically constrained to the manifold through twist-and-lock or push-to-lock systems to prevent the canister from backing off once pressure is applied.

With respect to the first approach, one of the drawbacks is that none of the seals are replaced when the filter canister is replaced and, in particular, that the inlet boss or large diameter boss seal is exposed partially to the ambient environment and tends to age much quicker than the internal seals used within the filter.

Accordingly, there is a need to provide a replaceable canister compatible with a manifold featuring a bayonet-style interface that also replaces outward sealing devices as those seals are exposed to air on one side. Due to varying environmental conditions such as low humidity and high temperatures, it would be advantageous to incorporate a design that makes the outward seal replaceable simultaneous to filter canister replacement.

### BRIEF DESCRIPTION OF EXAMPLE EMBODIMENTS OF THE INVENTION

As described herein, the exemplary embodiments of the present invention overcome one or more disadvantages known in the art. A first aspect of the present invention relates to filter canister apparatus for engagement with a manifold including an inlet annular recess defined by at least a first mating surface, and wherein the first mating surface is configured to retain a seal thereon, a seal retained on the first mating surface, and an outlet annular recess defined by at least a second mating surface, wherein the second mating surface is substantially continuous and free of sealing means.

A second aspect of the present invention relates to a filter canister apparatus including an inlet annular recess defined by at least a first mating surface, the first mating surface comprising an annular outer wall, and wherein the first mating surface comprises an annular slot for retention of a seal, a seal retained by the mating surface and an outlet annular recess defined by at least a second mating surface, wherein the second mating surface is substantially continuous and free of sealing means.

A third aspect of the invention relates to a system including the filter canister of the first or second aspect above in conjunction with a manifold having a manifold inlet port and a manifold outlet port, a check valve being disposed for fluidly sealing at least one of said ports, a radial channel defined within the manifold leading to the check valve, the manifold inlet port being operably fluidly coupled to the fluid source for receiving a flow of unfiltered fluid and to a flow inlet channel defined in the manifold, the manifold outlet port being fluidly coupled to a flow outlet channel defined in the manifold; the flow inlet channel having an intake opening for directing fluid conveyed therein, the intake opening defined in a lower margin of a depending inlet boss of the manifold, the inlet boss having a circular cross section defined about a longitudinal axis and an inlet boss circumferential outer margin; an outlet boss depending from the inlet boss and having a circular cross section defined about the longitudinal axis and a circumferential outer margin, the outlet boss also having an outlet opening for directing fluid conveyed therein, the outlet opening being fluidly coupled to the flow outlet channel, the flow outlet channel fluidly coupling the outlet opening to the manifold outlet port; and at least one annular manifold interlocking member being disposed radially outward of the inlet boss.

A fourth aspect of the invention relates to a filter canister apparatus including an inlet annular recess defined by at least a first mating surface, the first mating surface comprising the inner surface of an annular wall, an outlet annular recess with at least one outlet port defined in a bottom margin of the outlet annular recess, at least one annular canister interlocking member disposed radially outward of the outlet annular recess, and an internal seal disposed within the inlet annular recess to provide a seal between a flow of unfiltered fluid into the filter canister and the ambient environment.

Further, a fifth aspect relates to a system including the filter canister of the fourth aspect above in conjunction with a manifold having a manifold having a manifold inlet port and a manifold outlet port, a check valve being disposed for fluidly sealing at least one of said ports, a radial channel defined within the manifold leading to the check valve, the manifold inlet port being operably fluidly coupled to the fluid source for receiving a flow of unfiltered fluid and to a flow inlet channel defined in the manifold, the manifold outlet port being fluidly coupled to a flow outlet channel defined in the manifold; the flow inlet channel having an intake opening for directing fluid conveyed therein, the intake opening defined in a lower margin of a depending inlet boss of the manifold, the inlet boss having a circular cross section defined about a longitudinal axis and an inlet boss circumferential outer margin; an outlet boss depending from the inlet boss and having a circular cross section defined about the longitudinal axis and a circumferential outer margin, the outlet boss also having an outlet opening for directing fluid conveyed therein, the outlet opening being fluidly coupled to the flow outlet channel, the flow outlet channel fluidly coupling the outlet opening to the manifold outlet port; and at least one annular manifold interlocking member being disposed radially outward of the inlet boss.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 presents a water filter apparatus, in accordance with a non-limiting exemplary embodiment of the invention;

FIG. 2 presents components of a water filter apparatus, in accordance with a non-limiting exemplary embodiment of the invention;

FIG. 3 presents components of a filter canister, in accordance with a non-limiting exemplary embodiment of the invention;

FIG. 4 illustrates a cross-section view of a water filter apparatus, in accordance with a non-limiting example embodiment of the invention;

FIG. 5 illustrates an uninstalled position and installed position of a manifold and filter canister, in accordance with a non-limiting exemplary embodiment of the invention;

FIG. 6 presents a side view image of a bayonet, in accordance with a non-limiting exemplary embodiment of the invention;

FIG. 7 illustrates exploded and cross-section views of the filter canister cap and insert component, in accordance with a non-limiting example embodiment of the invention;

FIG. 8 illustrates an uninstalled position of a manifold and filter canister, which incorporates an integral lip seal, in accordance with a non-limiting exemplary embodiment of the invention;

FIG. 9 presents exploded and cross-section views of the filter canister cap and the integral lip seal, in accordance with a non-limiting exemplary embodiment of the invention; and

FIG. 10 illustrates an uninstalled position and installed position of a bayonet and filter canister, which incorporates an integral lip seal, in accordance with a non-limiting exemplary embodiment of the invention.

### DETAILED DESCRIPTION OF EXAMPLE EMBODIMENTS OF THE INVENTION

As described herein, one or more embodiments of the invention include techniques and apparatuses in connection with a seal addendum to a water filter canister.

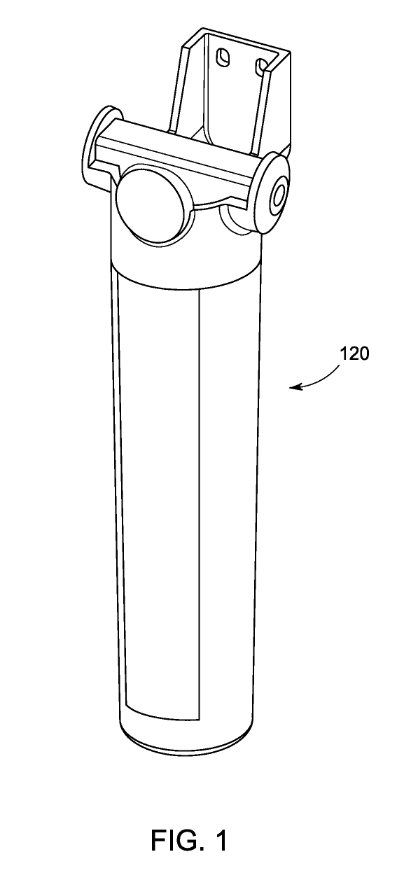

FIG. 1 illustrates a water filter apparatus 120, in accordance with a non-limiting exemplary embodiment of the invention. Individual components that constitute water filter apparatus 120 are depicted in the subsequent figures, and the individual components illustrated therein (as well as the numerical labels corresponding thereto) are used herein in describing one or more embodiments of the invention.

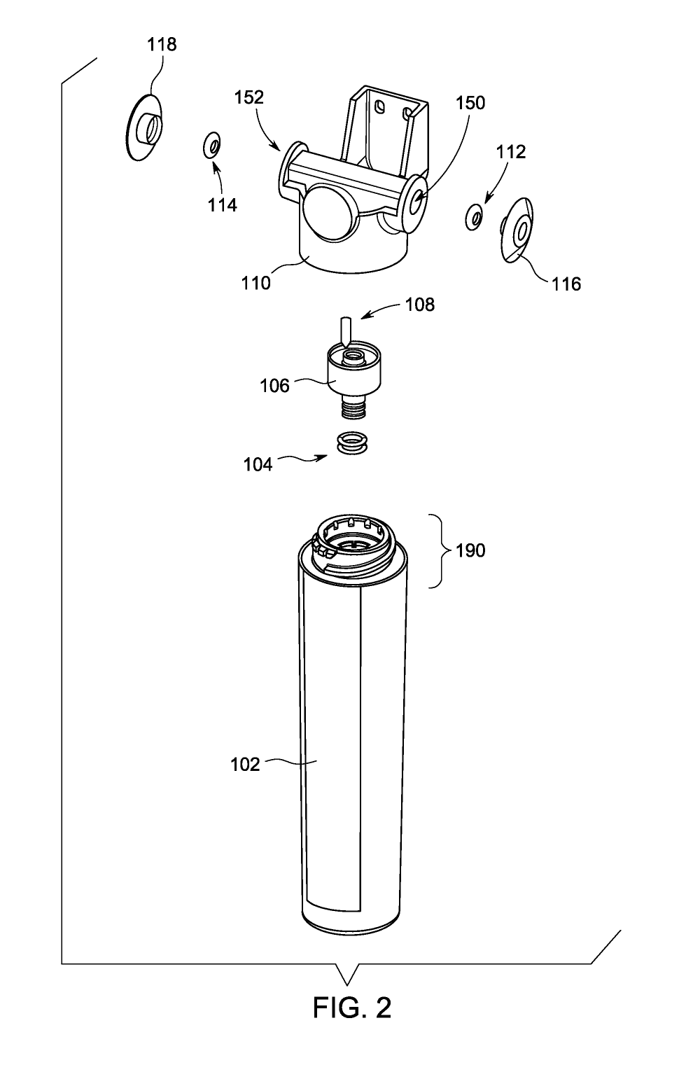

Accordingly, FIG. 2 presents components of the water filter apparatus 120 of FIG. 1, in accordance with a non-limiting exemplary embodiment of the invention. By way of illustration, FIG. 2 depicts a filter canister 102, o-rings 104, a bayonet 106, a check valve 108, a manifold body 110, o-ring 112 and o-ring 114, and speed-fit cap 116 and speed-fit cap 118. As shown in FIG. 2, the filter canister 102 additionally includes an annular canister interlocking member 190. Additionally, the manifold body 110 includes a manifold inlet port 152 and manifold outlet port 150. These components are discussed in further detail herein.

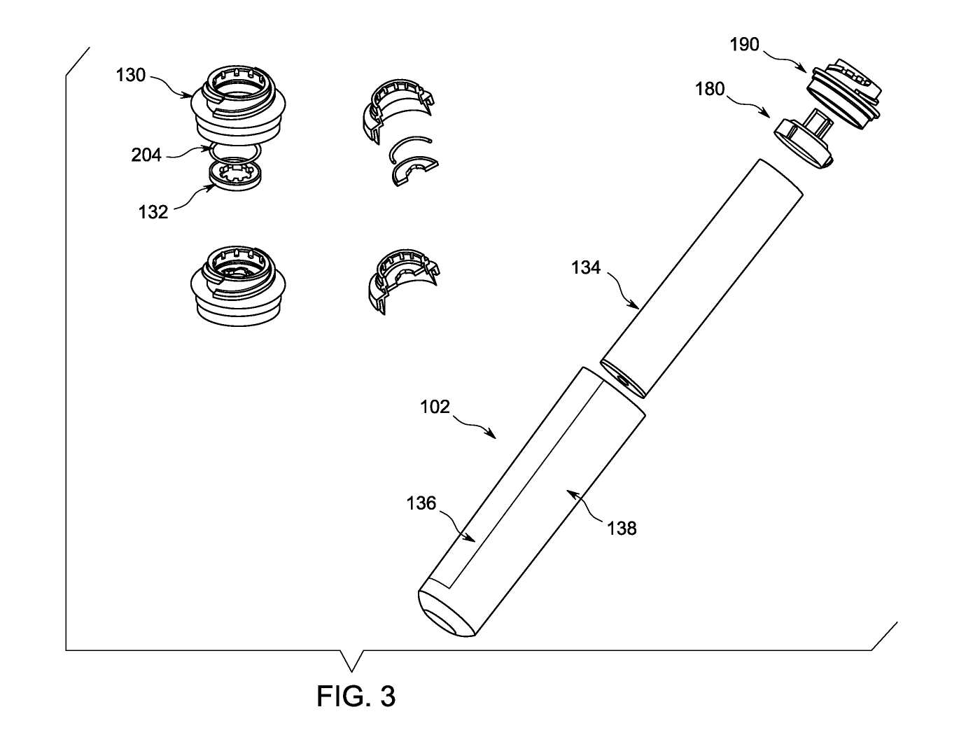

FIG. 3 illustrates components of the filter canister 102, in accordance with a non-limiting exemplary embodiment of the invention. By way of illustration, FIG. 3 depicts a filter cap 130, a compression seal in the form of an o-ring 204, and an insert component 132, which comprise the annular canister interlocking member 190. In at least one embodiment of the invention, the insert component 132 enables various methods of engaging the check valve 108. The engagement amount of the check valve 108 can vary from, for example, 0.050 inches to 0.1875 inches depending on how far the check valve 108 is to be pushed up. In an example embodiment, a 1/16″ diameter o-ring can be pushed around the check valve 108 up almost 1/16″ to break seal. Additional embodiments can include pushing higher (0 to 0.125″) to facilitate higher flow rates if desired or needed. Accordingly, in at least one embodiment of the invention, the check valve 108 engages the insert component 132 upon rotation of the filter canister 102 upon an approximately quarter turn of the filter canister 102, opening a passage-way through which fluid can pass.

FIG. 3 also depicts a media adapter cap 180 and a filter media structure assembly 134. As known in the art, the filter media structure assembly 134 can include one of multiple compositions. For example, the structure assembly 134 can include carbon, a reverse osmosis membrane, an ultra-filtration component (such as a hollow fiber cartridge), etc. Additionally, as depicted in FIG. 3, the filter canister 102 can include a polypropylene canister portion 136 and a soft touch santoprene canister portion 138.

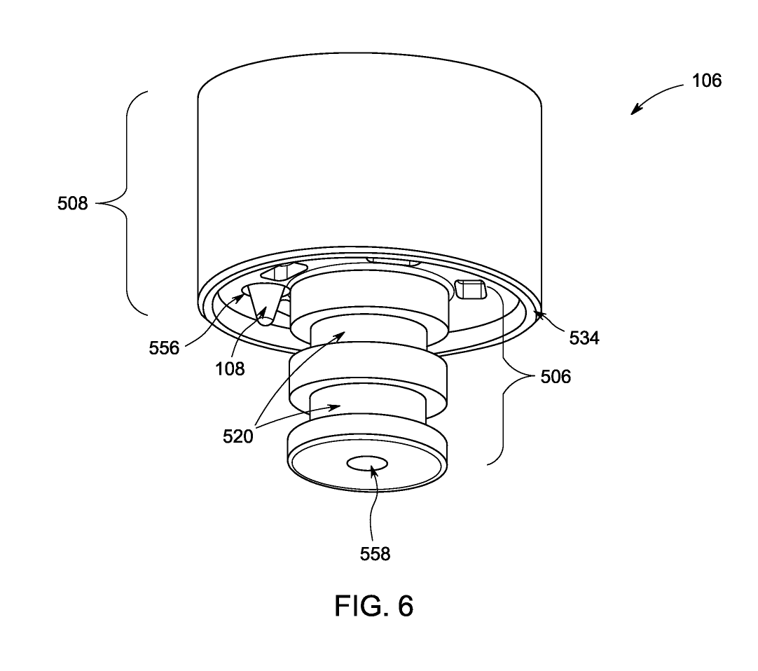

Also, at least one embodiment of the invention includes attaching a cartridge to a water filter head assembly, and more specifically, at least one embodiment of the invention includes adding an elastomeric seal component (such as o-ring 204) to the mating surface provided by the inner periphery of the annular canister interlocking member 190 to sealingly engage the external cylindrical surface of the inlet boss portion (depicted as component 508 in FIG. 6) of the bayonet 106 as the filter canister 102 is installed.

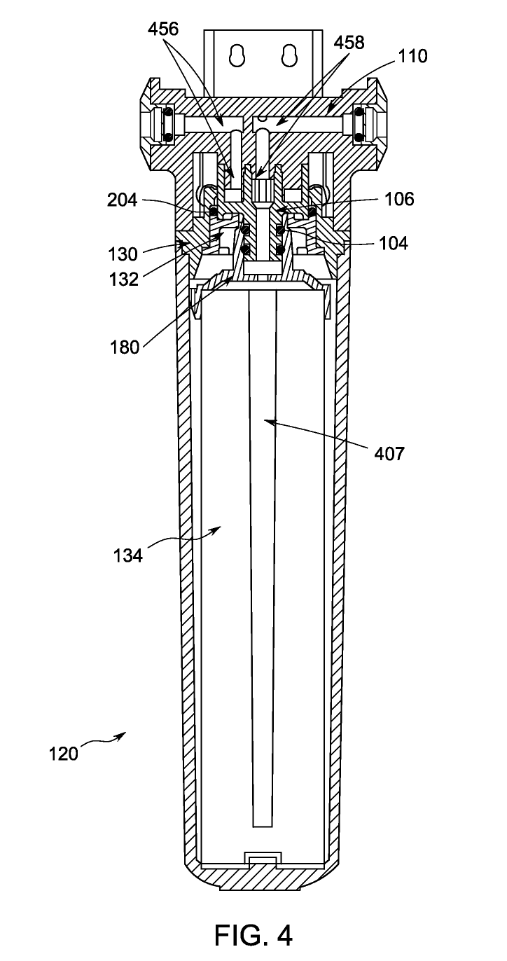

FIG. 4 illustrates a cross-section view of water filter apparatus 120, in accordance with a non-limiting exemplary embodiment of the invention. Specifically, FIG. 4 shows manifold body 110, bayonet 106, a flow inlet channel 456 defined within the manifold body 110 leading to the check valve 108, and a flow outlet channel 458 defined in the manifold body 110. The manifold inlet port 152 is operably fluidly coupled to a fluid source for receiving a flow of unfiltered fluid, and is also fluidly coupled to the flow inlet channel 456. The manifold outlet port 150 is fluidly coupled to flow outlet channel 458.

FIG. 4 also shows filter canister cap 130, insert component 132, media adapter cap 180, and the filter media structure assembly 134. As is known in the art, there are commonly two different filter media structure assembly types—carbon blocks and hollow fiber. The hollow fiber includes a plastic outer shell that contains the hollow fiber into a bundle. This bundle is potted in the shell such that water passes from outside the fibers into the center of individual fibers, where it flows through the fiber to a common outlet atop the cartridge. The insert component 132 (or in one or more embodiments, the filter canister cap 130) includes a centrally located hole or channel on the horizontal surface that acts to locate the filter media structure assembly 134 radially within the filter canister 102 and direct fluid thereto. The upwardly extending cylindrical portion of the cap 180 fits into the centrally located hole in insert component 132 to locate the media. Further, the media adapter cap 180 can be a portion of the filter media structure assembly 134 or coupled to the filter media structure assembly 134 as a separate component.

As noted above, new filters are being engineered to extract more contaminants at higher flow rates due to changes in both the media and filter geometry. By way of example, cartridges filled with hollow fiber media can be capable of removing bacterial and viral microorganisms down to a 15 nanometer size. Another media, as mentioned, includes a traditional carbon block, where the surface area has been increased by almost 50% but volume correspondingly only by approximately 20%.

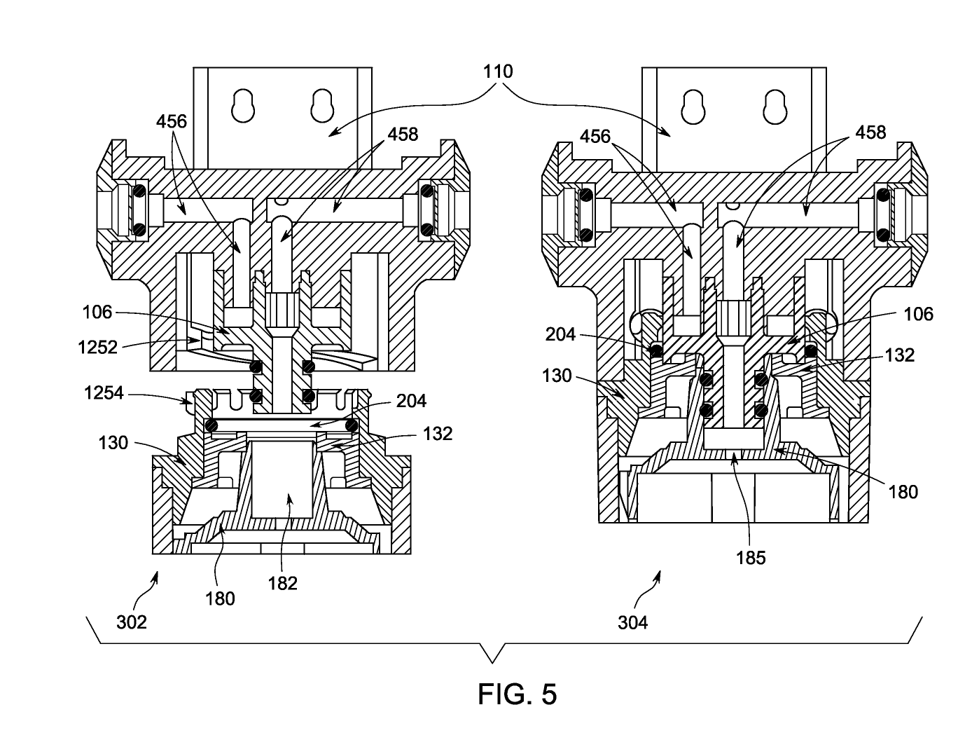

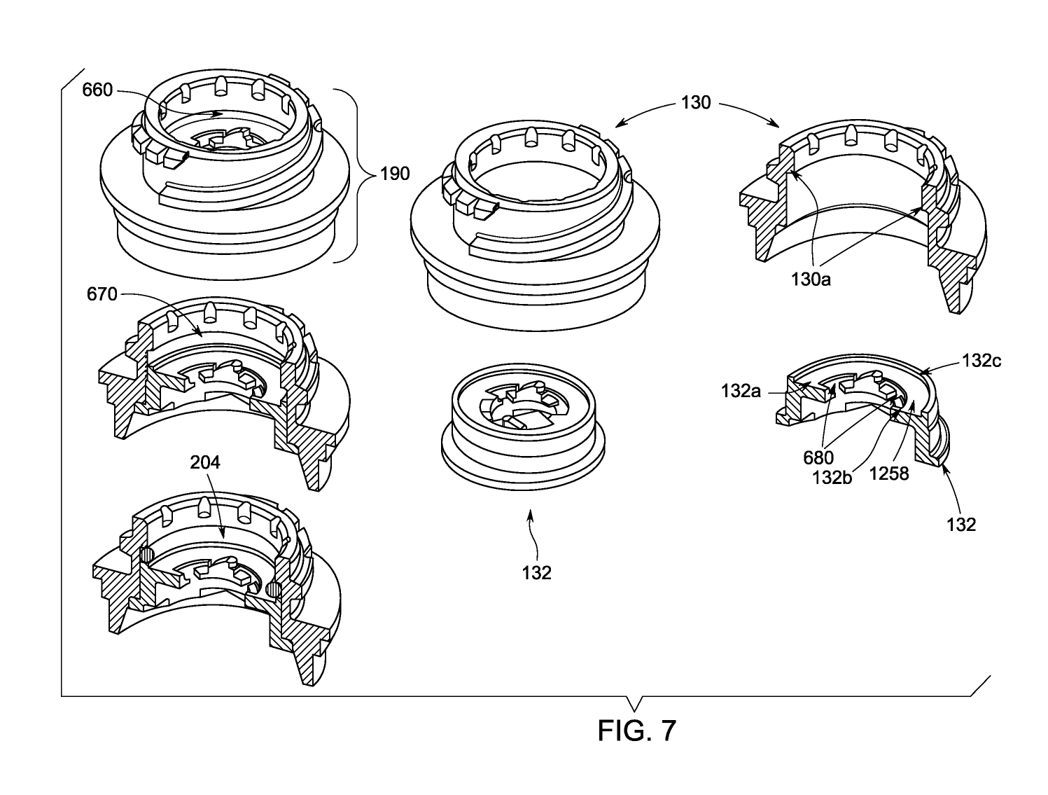

FIG. 5 presents an image representing the uninstalled position 302 and the installed 304 position of the manifold body 110 and filter canister 102, in accordance with a non-limiting exemplary embodiment of the invention. In addition to the components also depicted in FIG. 4, FIG. 5 illustrates a spiraling shoulder flange 1252 on the manifold body 110 and a flange 1254 on the filter canister cap 130. Rotation of the flange 1254 on the filter canister cap 130 with respect to the manifold flange 1252 on the manifold body 110 acts to engage the filter canister 102 and the manifold body 110 and draw them together in an axial direction into a tight fit. Additionally, FIG. 5 identifies o-ring 204, which is described further in connection with FIG. 7. Moreover, the uninstalled 302 and installed 304 position of the manifold body 110 and filter canister 102 depicted in FIG. 5 illustrate how the bayonet 106 fits into the filter canister 102 and more specifically how inlet boss (depicted as component 508 in FIG. 6) of the bayonet 106 is received in sealing engagement with a first mating surface provided in this embodiment by an interior annular surface 660 of interlocking member 190, which is formed by the inner surface of the side wall of cap 130 together with the upwardly extending outer rim 132c of insert component 132, as further illustrated in FIG. 7.

Additionally, FIG. 5 depicts how outlet boss 506 is received into the inlet annular recess defined in this embodiment by the hollow cylindrical interior 182 of media adapter cap 180 and seals off against a second mating surface illustratively embodied by the interior surface of the upwardly extending cylindrical sidewall of the media adapter cap 180. It should be noted that in this embodiment this second mating surface is continuous and has no sealing means.

FIG. 6 illustrates a side view image of bayonet 106. As described herein, bayonet 106 is a protrusion that comes down off of the bottom of the manifold body 110 for sealing engagement with the filter canister 102. As noted, the bayonet 106 can, by way of example, be welded via ultrasonic, spin, or heat-stake means into the manifold body 110, thereby establishing a water flow path. The smaller diameter portion, also referred to herein as an outlet boss 506 of the bayonet 106, which includes annular spaces 520 for fitting o-rings 104 if desired, fits into the hollow cylindrical interior 182 of media adapter cap 180 in the middle of filter canister 102 to form a seal therebetween. By way of illustration, FIG. 4 depicts a double o-ring seal engaging the media adapter cap 180 of the filter media, wherein the o-rings (such as depicted as components 104 in FIG. 2) squeeze into the media adapter cap 180 to form a seal.

The fluid exiting the filter travels up through the flow outlet channel 458 (as depicted in FIG. 4) in the middle of the bayonet 106 and is ultimately directed out of the manifold body 110. The seal between outlet boss 506 and the filter canister 102 prevents the water exiting the filter canister 102 from leaking around outlet boss 506. The larger diameter portion, also referred to herein as an inlet projection or inlet boss 508 of the bayonet 106, provides a surface for sealingly engaging the filter canister 102 and more particularly for sealingly engaging a mating surface provided in this embodiment by an interior annular surface 660 of interlocking member 190, which is formed by the inner surface of the side wall of cap 130 together with the outer rim 132c of insert component 132, as hereinafter more fully described in reference to FIG. 7, to prevent the unfiltered fluid entering the filter canister 102 through the check valve 108 from leaking to the ambient environment outside of the manifold body 110.

As described and depicted herein, bayonet 106 includes the flow inlet channel 456 (as depicted in FIG. 4) around check valve 108 having a discharge opening 556 for discharging the fluid conveyed therein to the filter canister 102. The discharge opening 556 is defined in a lower margin of depending inlet boss 508. The inlet boss 508 has a circular cross section defined about a longitudinal axis and a circumferential outer margin. Additionally, an outlet opening 558 is fluidly coupled to the flow outlet channel 458. Further, the flow outlet channel 458 fluidly couples the outlet opening 558 to the manifold outlet port 150.

Accordingly, the bayonet 106 receives fluid flow from the manifold inlet port 152 in the manifold body 110. The bayonet 106 distributes the flow into the inlet boss 508 to the discharge opening 556 defined in the lower margin of the bayonet 106. Further, as is known in the art, structural support features above the discharge opening 556 can be provided to align and guide the movement of the check valve 108 along the longitudinal axis of the discharge opening 556.

As noted above, when engaged with the filter canister 102, the large diameter cylinder or inlet boss 508 provides a sealing surface for engagement with a first mating surface provided by an interior annular surface 660 of interlocking member 190, which is formed by the inner surface of the side wall of cap 130 together with the upwardly extending rim 132c of insert component 132, to provide a seal between the incoming, unfiltered fluid and ambient environment. The smaller diameter cylinder or outlet boss 506, when engaged with the filter canister 102, fits and forms a seal against cylindrical interior 182 of media adapter cap 180 and directs filtered fluid toward the exit of the manifold body 110. Each of these bayonet cylinders may, merely by way of example, include an o-ring or a set of o-rings as well as a set of glands to facilitate a proper seal.

On the bottom horizontal surface of the inlet boss 508, a plunger of the check valve 108 protrudes downward and is biased into this position via a mechanical spring within the check valve 108. This plunger is depressed upward as it engages a complementary surface on the filter canister 102 when the filter canister 102 is being installed in the manifold body 110, which surface may comprise recessed sumps or raised protrusions, depending on orientation of the check valve 108, as is known in the art.

Further, as detailed herein, an embodiment of the invention can seal against a bayonet (such as bayonet 106) that already includes an o-ring mounted on the periphery the inlet boss 508. However, such an embodiment of the invention does not require the presence of such a bayonet o-ring in order to form a seal.

FIG. 7 illustrates exploded and cross-section views of the filter canister cap 130 and insert component 132. Additionally, FIG. 7 depicts the annular canister interlocking member 190, including the interior annular surface 660 of interlocking member 190, which comprises a first mating surface as detailed herein. Further, FIG. 7 depicts an o-ring groove 670 for receiving and retaining o-ring 204. The groove 670 is formed, in the embodiment illustrated in FIG. 7, in the first mating surface formed by the upper edge of rim 132c on the insert component 132 and the inner bottom annular surface 130a on the filter canister cap 130 proximate the intersection of cap 130 and insert component 132. Additionally, the insert component 132, in at least one embodiment of the invention, is spun welded into the filter canister cap 130. In an example embodiment, the o-ring 204 sealingly engages the vertical walls of the inlet boss 508 of the bayonet 106 during installation in lieu of and/or conjunction with an existing o-ring installed on the outlet boss 506 of the bayonet 106. Specifically, as detailed herein, boss sealing means of the bayonet 106 include o-rings 104 positioned in annular spaces 520 to seal the space between the outlet boss 506 and the second mating surface, provided in the embodiments herein described by the inner periphery of the filter canister cap 130, when fully assembled.

FIG. 7 also depicts an annular recess 1258 formed by the upper facing surface 132a of the insert component 132, extending between inner upwardly extending rim 132b and outer upwardly extended rim 132c, as well as slot features 680 located around the inner hole of the insert component 132. In at least one embodiment of the invention, fluid entering via discharge opening 556 in inlet boss 508 travels into the inlet recess 1258 between the bayonet 106 and the surface 132a of the insert component 132 into the interior space between the filter canister cap 130 and the exterior surface of the media adapter cap 180, through the slot features 680 located around the central hole in the insert component 132. From this region the water flows into the space between the filter media and the cylindrical wall of canister 102 and then radially inwardly through filter media structure assembly 134 to the central bore media structure 407 of the assembly 134 and exits the canister through the central opening 185 in cap 180 to outlet channel 458 of manifold 110 which passes through outlet boss 506.

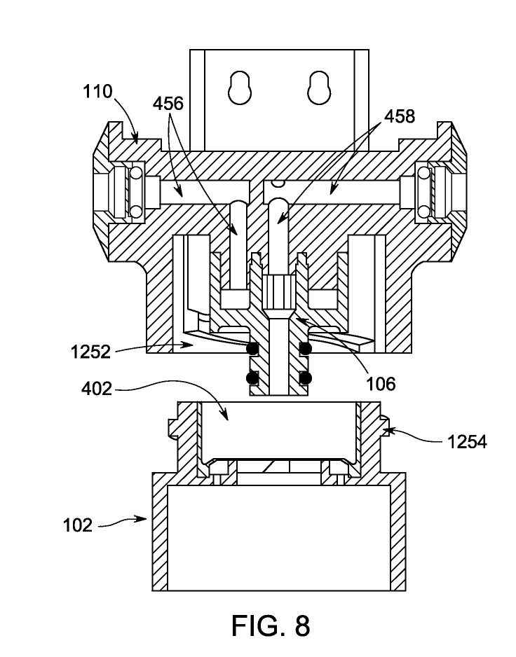

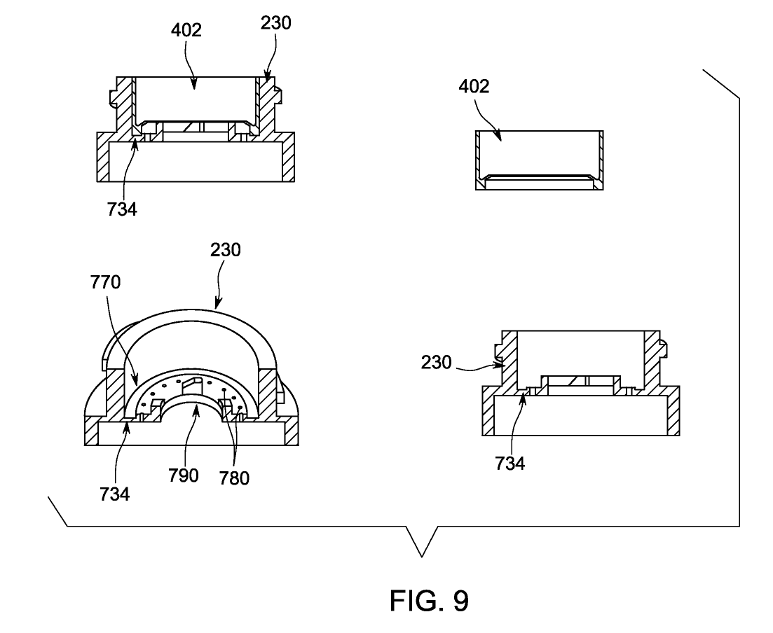

FIG. 8 presents another embodiment providing a seal between a first mating surface of the filter canister 102 and the bayonet 106 of the manifold, body 110 comprising an integral lip seal 402, in accordance with a non-limiting exemplary embodiment of the invention. Specifically, FIG. 8 depicts the integral lip seal 402 fit within the filter canister 102, as further detailed below in connection with FIG. 9. Integral lip seal 402 can include, for example, an elastomeric seal formed into the filter canister 102 (for example, to the inner periphery of the filter canister cap 230) to seal against the bottom of the bayonet 106, and allow a seal to form against the manifold body 110 (whether the manifold body 110 contains o-rings on the inlet boss 508 or not). In this embodiment, the first mating surface is provided by the annular surface 734 in the interior of filter canister cap 230. Lip seal 402 is supported from the first mating surface for sealing engagement with the lower most external surface 534 of inlet boss 508 when the filter cartridge is fully installed with the manifold. An annular groove 770 is formed in surface 734 to receive the lip seal 402.

The integral lip seal 402 can be bonded, for example, via insert molding or adhesive into the filter canister 102. The integral lip seal 402 can also include, in at least one embodiment of the invention, an interference mechanism (such as, for example, a cantilever lip) that engages with the flow inlet channel 456 upon engaging the filter canister 102 to the manifold body 110.

Additionally, according to an example embodiment of the invention, when the filter canister 102 is engaged and rotated (for example, a quarter turn), the integral lip seal 402 pushes up against the bottom of inlet boss 508 of the bayonet 106 and forms a seal. Additionally, water pressure within the filter can push the lip 402 harder against the bayonet surface to enhance the sealing action. As detailed herein, the lower margin of the inlet boss 508 is sealed via the integral lip seal 402 and can be further sealed during pressurization.

FIG. 9 presents exploded and cross-section views of the filter canister cap 230 and the integral lip seal 402, in accordance with a non-limiting exemplary embodiment of the invention. Specifically, FIG. 9 depicts an annular groove 770 formed into the filter canister cap 230 for receiving the integral lip seal 402. Additionally, FIG. 9 depicts canister cap holes 780 in the filter canister cap 230. At least one embodiment of the invention uses these cap holes 780 through the bottom of the filter canister cap 230 to direct inlet water into the filter canister 102 (similar to the example embodiment described herein using the slot features 680 located around the inner hole of the insert component 132).

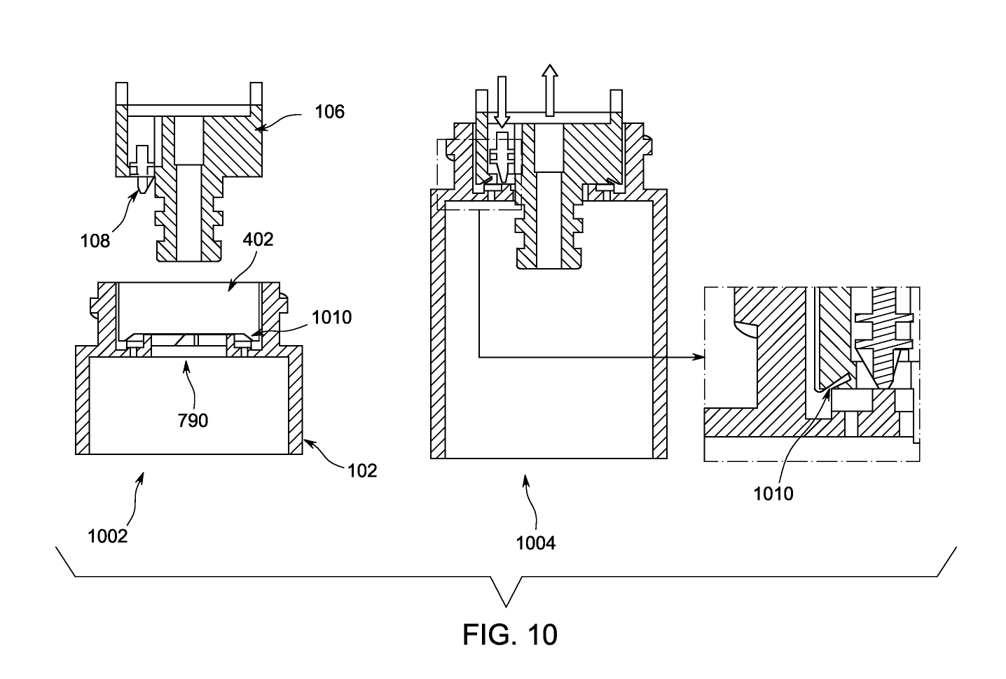

FIG. 10 illustrates an uninstalled position 1002 and installed position 1004 of the bayonet 106 and filter canister 102, which incorporates integral lip seal 402, in accordance with a non-limiting exemplary embodiment of the invention. As illustrated, upon installation of the bayonet 106 through canister cap recess 790, the lip seal 402 is engaged via interference with the canister 102 and assisted by pressurization. The interference mechanism can include, as depicted in FIG. 10, a cantilever lip 1010. Additionally, as illustrated, upon installation, the check valve 108 positioned on the bayonet 106 engages with the canister cap 130 and is pressed upwards, as further detailed herein.

As noted, one advantage that may be realized in the practice of some embodiments of the described systems and techniques is creating a seal without requiring an o-ring to be carried on the inlet boss 508 of the bayonet 106.

Thus, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A filter canister apparatus for engagement with a manifold, said apparatus comprising:
an inlet annular recess defined by at least a first mating surface, and wherein the first mating surface is configured to retain a seal thereon;
a seal retained on the first mating surface; and
an outlet annular recess defined by at least a second mating surface, wherein the second mating surface is substantially continuous and free of sealing means.

2. The apparatus of claim 1, wherein the seal comprises an o-ring.

3. The apparatus of claim 1, wherein the seal comprises an elastomeric seal.

4. The apparatus of claim 1, wherein the seal comprises an interference mechanism.

5. The apparatus of claim 1, wherein the seal forms a seal against an inlet boss of the manifold upon engaging the filter canister to the manifold.

6. The apparatus of claim 5, wherein the seal presses against the bottom surface of an inlet boss operably coupled to the flow inlet channel to block fluid flow from moving to the ambient environment.

7. The apparatus of claim 1, wherein the seal forms a seal against an inlet boss of the manifold via water pressure within the filter canister that pushes the seal against the inlet boss.

8. A filter canister apparatus comprising:
an inlet annular recess defined by at least a first mating surface, the first mating surface comprising an annular outer wall, and wherein the first mating surface comprises an annular slot for retention of a seal;
a seal retained on the first mating surface; and
an outlet annular recess defined by at least a second mating surface, wherein the second mating surface is substantially continuous and free of sealing means.

9. The apparatus of claim 8, wherein the seal comprises an o-ring.

10. A fluid filtration system comprising:
a manifold having a manifold inlet port and a manifold outlet port, a check valve disposed for fluidly sealing at least one of said ports, a flow inlet channel leading to the check valve, the manifold inlet port operably fluidly coupled to a fluid source for receiving a flow of fluid and to a flow inlet channel, the manifold outlet port fluidly coupled to a flow outlet channel;
the flow inlet channel having an intake opening for directing fluid conveyed therein, the intake opening defined in a margin of a depending inlet boss of the manifold;
an outlet boss depending from the inlet boss and having a circumferential outer margin, the outlet boss also having an outlet opening for directing fluid conveyed therein, the outlet opening fluidly coupled to the flow outlet channel, the flow outlet channel fluidly coupling the outlet opening to the manifold outlet port; and
a filter canister having:
an inlet annular recess defined by at least a first mating surface, and wherein the first mating surface is configured for retention of a seal;
a seal retained on the first mating surface; and
an outlet annular recess defined by at least a second mating surface, wherein the second mating surface is substantially continuous and free of sealing means.

11. The system of claim 10, wherein the seal comprises an interference mechanism.

12. The system of claim 10, wherein the seal comprises an o-ring.

13. A filter canister apparatus comprising:
at least on annular canister interlocking member comprising an inlet annular recess defined at least in part by an annular wall comprising an inner surface, the inner surface providing a first mating surface;
an outlet annular recess with at least one outlet port defined in a bottom margin of the outlet annular recess; and
an internal seal disposed within the interlocking member proximate the first mating surface to provide a seal between a flow of unfiltered fluid into the filter canister and the ambient environment.

14. The apparatus of claim 13, wherein the internal seal comprises an o-ring.

15. The apparatus of claim 13, further comprising:
an annular insert component coincident with the at least one annular canister interlocking member; said insert component comprising an inner rim, an outer rim and an annular surface extending therebetween; and
wherein the upper edge of the outer rim of the annular insert component defines a lower side of an o-ring groove within the at least one annular canister interlocking member and wherein the o-ring is disposed in the groove.

16. The apparatus of claim 15, wherein the outer side and upper sides of the o-ring groove are defined by the inner wall of the at least one annular canister interlocking member.

17. A fluid filtration system comprising:
a manifold having a manifold inlet port and a manifold outlet port, a check valve disposed for fluidly sealing at least one of said ports, a flow inlet channel leading to the check valve, the manifold inlet port operably fluidly coupled to a fluid source for receiving a flow of fluid and to a flow inlet channel, the manifold outlet port fluidly coupled to a flow outlet channel;
the flow inlet channel having an intake opening for directing fluid conveyed therein, the intake opening defined in a margin of a depending inlet boss of the manifold;
an outlet boss depending from the inlet boss and having a circumferential outer margin, the outlet boss also having an outlet opening for directing fluid conveyed therein, the outlet opening fluidly coupled to the flow outlet channel, the flow outlet channel fluidly coupling the outlet opening to the manifold outlet port; and
a filter canister having:
an inlet annular recess defined by at least a first mating surface, the first mating surface comprising an annular wall;
an outlet annular recess with at least one outlet port defined in a bottom margin of the outlet annular recess; and
an internal seal disposed on the first mating surface to provide a seal between a flow of unfiltered fluid into the filter canister and the ambient environment.

18. The system of claim 17, wherein the internal seal comprises an o-ring.

19. The system of claim 17, further comprising:
an annular insert component coincident with the at least one annular canister interlocking member; said insert component comprising an inner rim, an outer rim and an annular surface extending therebetween,
wherein the upper edge of the outer rim of the annular insert component defines a lower side of an o-ring groove within the at least one annular canister interlocking member and wherein the o-ring is disposed in the groove.

20. The system of claim 19, wherein the outer side and upper sides of the o-ring groove are defined by the inner wall of the at least one annular canister interlocking member.
